(19) United States
(12) Patent Application Publication
(10) Pub. No.: US 2008/0200247 A1
(43) Pub. Date: Aug. 21, 2008

(54) Game system having main display viewable by a plurality of players

(75) Inventor: Kazumasa Yoshizawa, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: ARUZE CORP., Tokyo (JP)

(21) Appl. No.: 12/010,417

(22) Filed: Jan. 24, 2008

(30) Foreign Application Priority Data
Jan. 25, 2007 (JP) P2007-015298

(51) Int. Cl. A63F 13/00

(52) U.S. Cl. 463/31

(57) ABSTRACT

A game system provides a game in which a plurality of players participate and includes: a first display unit that displays an image related to the game; a plurality of stations that are provided for each of the players to play the game and arranged at positions where the image displayed on the first display unit is viewable by each of the players; a plurality of camera devices that are respectively provided in each of the stations and capture facial images of the respective players; and a controller that operates to: control at least one of the camera devices to capture the facial images; and control the first display unit to display the facial images captured by the camera devices.

### CROSS-REFERENCE TO THE RELATED APPLICATION(S)

The present application is based upon and claims priority from prior Japanese Patent Application No. 2007-015298, filed on Jan. 25, 2007, the entire content of which are incorporated herein by reference.

### TECHNICAL FIELD

The present invention relates to a game system having a common main display that can be viewed by a plurality of players.

### BACKGROUND

An example of conventional multi-player games, such as poker games which use cards or the like, is disclosed in WO-A1-97026061. An example of multi-player-tournament games is disclosed in WO-A1-00071218. An example of game systems for providing award to players through a network in gambling is disclosed in WO-A1-02041233.

In a game that is played while a plurality of players view a common main display, facial expressions of other players or reactions of audiences (for example, cheers and clamors) viewing the game have an effect on psychology of the players and are considerable factor in playing the game. However, when the players play the game side by side, it is difficult to directly view the facial expressions of other players. Accordingly, it is difficult to guess whether the game proceeds to be advantageous to other players, and thus it is difficult to set up a strategy, and thereby amusement in the game becomes insufficient in terms of tactically playing the game.

In the above-described games, generally, the players play the games on the front side of the main display. Thus, when the main display is disposed on the wall side, positions in which the audiences can stand are limited to the players' rear side or the player's side, and thereby it is difficult for the audiences to directly recognize facial expressions of the players visually which change in accordance with the progress of the game. Accordingly, for the audiences viewing the game, amusement of the game becomes insufficient. Furthermore, since it is difficult to visually recognize the facial expressions of the players, reactions of the audiences become insensitive, and thereby a heightened atmosphere of the game cannot be made.

### SUMMARY

One of objects of the present invention is to provide a new entertaining feature that cannot be provided by using the conventional technology. In particular, one of objects of the present invention is to provide a game system capable of increasing enjoyment of tactical play in a game and enjoyment of viewing the game and encouraging the whole aspects of the game.

According to one aspect of the invention, there is provided a game system that provides a game in which a plurality of players participate, the game system including: a first display unit that displays an image related to the game; a plurality of stations that are provided for each of the players to play the game and arranged at positions where the image displayed on the first display unit is viewable by each of the players; a plurality of camera devices that are respectively provided in each of the stations and capture facial images of the respective players; and a controller that operates to: control at least one of the camera devices to capture the facial images; and control the first display unit to display the facial images captured by the camera devices.

### BRIEF DESCRIPTION OF THE DRAWINGS

In the accompanying drawings:

FIG. 1 is a diagram showing an example of an image displayed on a front display included in a game system according to an embodiment of the present invention;

FIG. 2 is a schematic perspective view showing the appearance of a game system according to the embodiment;

FIG. 3 is a schematic top view of a game system according to the embodiment;

FIG. 4 is a schematic perspective view showing the appearance of a station included in a game system according to the embodiment;

FIG. 5 is a diagram showing an example of an image displayed on a liquid crystal display included in the station;

FIG. 6 is a block diagram showing the internal configuration of a game system according to the embodiment;

FIG. 7 is a block diagram showing the internal configuration of a station according to the embodiment;

FIG. 8 is a flowchart showing a game process according to the embodiment;

FIG. 9 is a flowchart showing a game process according to the embodiment;

FIG. 10 is a flowchart showing a subroutine for a process of transmitting a command for receiving a selection which is performed by a main control unit;

FIG. 11 is a flowchart showing a subroutine for a process of displaying the face image of a designated player which is performed at regular time intervals by the station and the main control unit, independently of the game process shown in FIGS. 9 and 10; and

FIG. 12 a perspective view showing the appearance of a game system according to another embodiment of the present invention.

### DETAILED DESCRIPTION

Embodiments of the present invention will now be described with reference to the accompanying drawings.

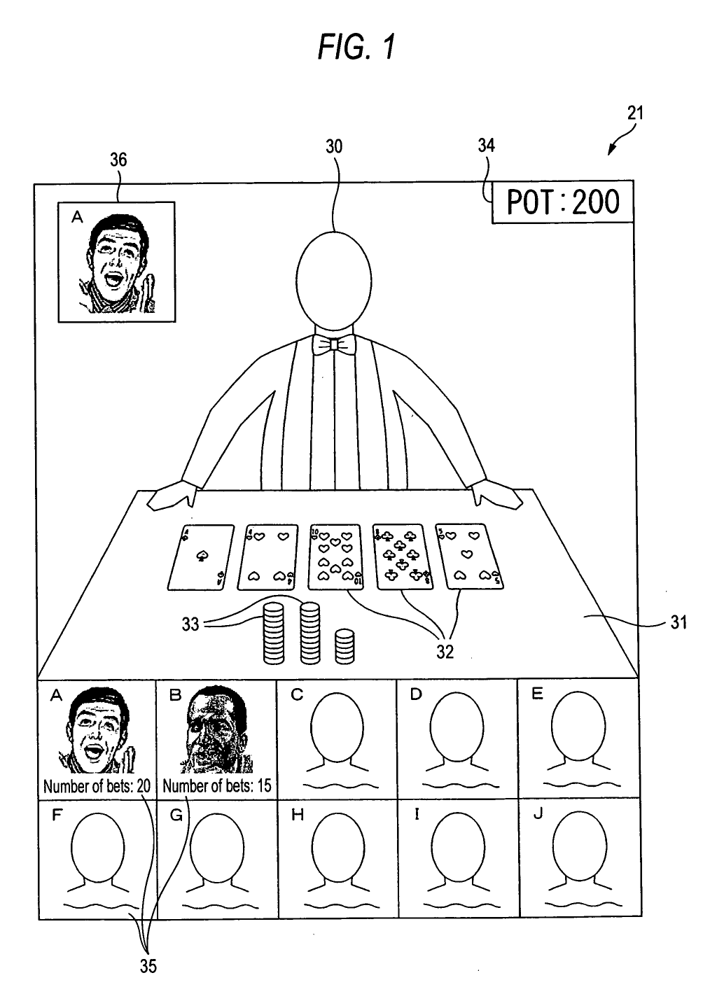

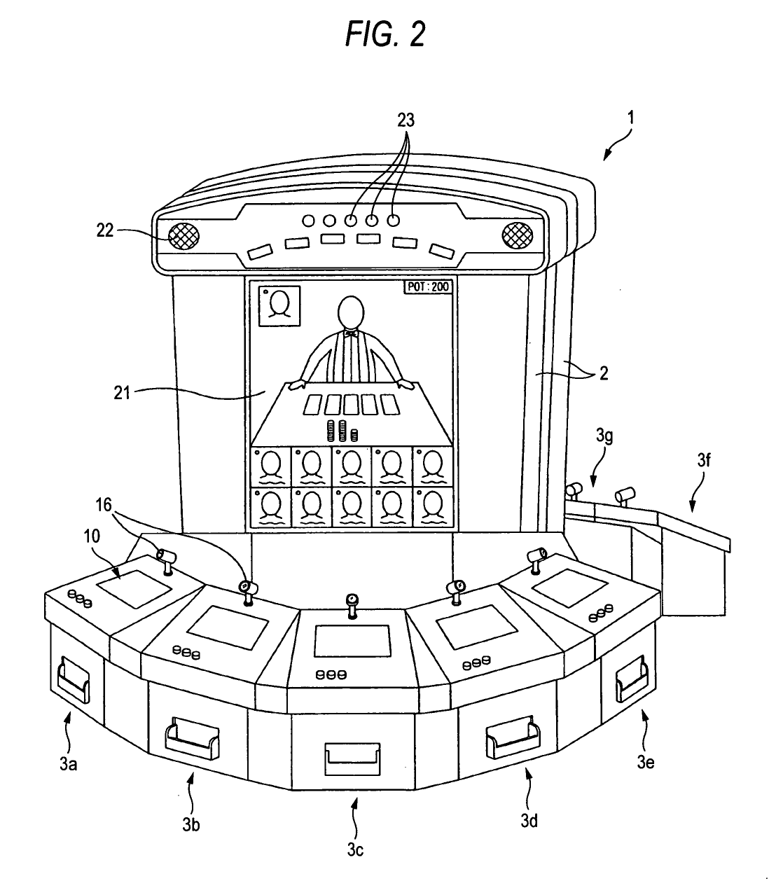

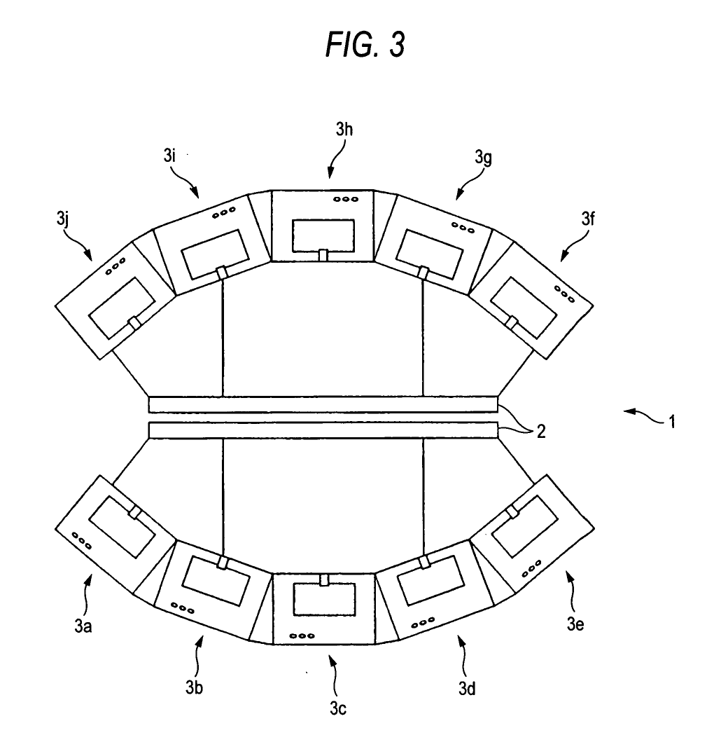

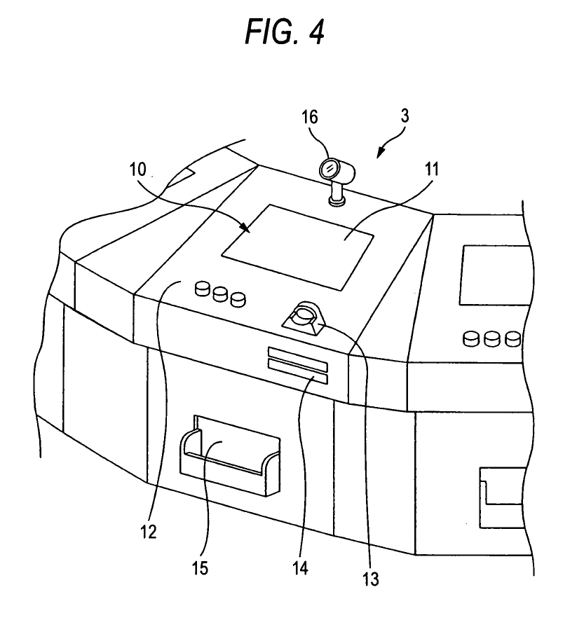

FIG. 1 is a diagram showing an example of an image displayed on a front display included in a game system according to the embodiment. FIG. 2 is a schematic perspective view showing the appearance of a game system according to the embodiment. FIG. 3 is a schematic top view of a game system according to the embodiment. FIG. 4 is a schematic perspective view showing the appearance of a station included in a game system according to the embodiment.

As shown in FIG. 1, on a lower side of the front display 21 of the game system 1 (see FIG. 2) according to the embodiment, ten game information display sections 35 are arranged. Alphabets of A to J displayed in the game information display sections 35 correspond to stations 3a to 3j (see FIGS. 2 and 3) of the game system 1. In each game information display section 35, a face image of a player using a corresponding station 3 (hereinafter, also referred to as a face image) and information on the game of the player (hereinafter, also referred to as game information) are displayed. For example, in the game information display sections 35 of “A” and “B”, face images and current numbers of bets of players currently participating in the game are displayed. Although, in the game information display sections 35 of “C” to “J”, the same types of face images and game information as displayed in the game information display sections 35 of “A” and “B” are displayed, however, in FIG. 1, the face images and game information are omitted.

In the game system 1, faces of players playing a game in the stations 3 are captured by using cameras 16 (see FIGS. 2 and 4) installed to the stations 3 and the acquired images are displayed in the game information display sections 35 corresponding to the stations 3.

In the embodiment, the images captured by the cameras 16 are motion pictures. As long as a game is played in two or more stations 3, image capturing operations performed by the cameras 16 installed to the stations 3 in which the game is played are continuously performed. In particular, from a time when coins are inserted into the station 3 to a time when all the coins are paid out or consumed in the station 3, an image capturing operation performed by the camera 16 installed to the station 3 is performed. The image acquired by the image capturing operation is immediately displayed in the game information display section 35 of the front display 21.

Next, the game system 1 according to the embodiment will be described.

As shown in FIG. 2, two main displays 2 are disposed in back-to-back arrangement in the game system 1. Each main display 2 has a front display 21 on which an image of a dealer, face images of the players, game information, and the like are displayed, speakers 22 that are disposed above the front display 21 and output music or effect sounds in accordance with progress of the game, and LEDs 23 that are turned on for providing various visual effects.

The main display 2 serves as a first display unit according to the present invention.

As shown in FIGS. 2 and 3, ten stations 3 (in a counter clockwise direction from the lower left end in FIG. 2, referred to as a station 3a, a station 3b, . . . , a station 3i, and a station 3j) are disposed to surround two main displays 2 of the game system 1. The description of “being disposed to surround a main display” means that a plurality of stations are installed in a range (there may be a discontinued portion) covering larger than 180 degrees to the left and right sides of the main display in which the display screen of the main display can be viewed. When two display screens of main displays 2 are arranged in back-to-back arrangement as in the embodiment, a case where the main displays 2 are interposed between pluralities of stations and each plurality of stations is installed in positions in which one of the display screens of the main displays 2 can be viewed is included in the description of “being disposed to surround the main display”.

According to an embodiment of the present invention, the number of the stations may be two or more and is not limited to ten.

As shown in FIG. 4, on the inner side of the upper face of the station 3, a camera 16 used for capturing an image of a player's face is disposed.

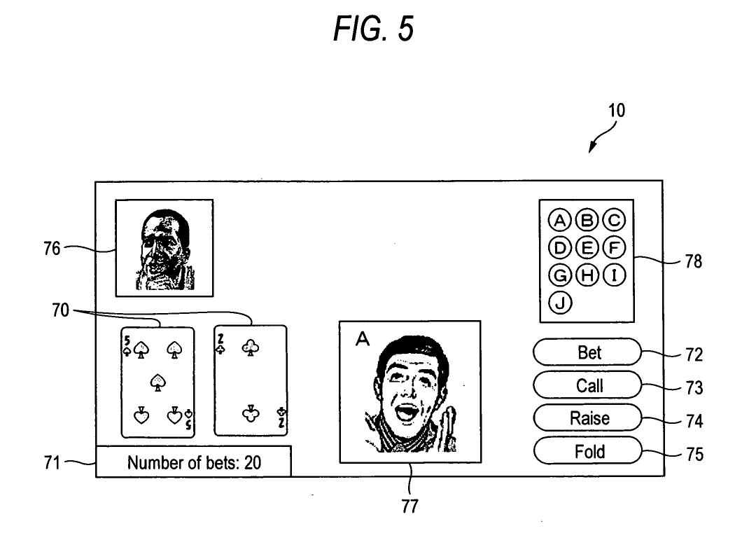

In front of the camera 16, a liquid crystal display 10 for displaying an image (see FIG. 5) relating to an operation, to be described later, the result of a game, or the like is disposed. The liquid crystal display 10 serves as a second display unit according to the present invention.

On the upper side of the liquid crystal display 10, a touch panel 11 for a player to input an operation is disposed.

In front of the liquid crystal display 10, an operation button 12 for performing a payout operation and a coin insertion slot 13 for inserting a coin or medal is disposed.

In the upper right end of the front side of the station 3, a bill insertion slot 14 for inserting a bill is disposed. Below the bill insertion slot 14, a coin payout opening 15 for paying out a player coins or medals corresponding to stored credits in a case where a payout operation is performed is disposed.

In the game system 1, Hold'em Poker is performed as a game.

Here, the Hold'em Poker rule will be described.

In Hold'em Poker, one set (52 cards) of playing cards excluding Joker is used.

First, a dealer deals two cards to each player. Each player refers to the cards dealt to him and selects one behavior among betting chips (hereinafter, also abbreviated as “bet”), betting chips of the same amount as the former player (hereinafter, referred to as “call”), raising the bet amount (hereinafter, also referred to as “raise”), and completing a game without placing a bet (hereinafter, also referred to as “fold”). Hereinafter, this selection is called as a bet selection.

Next, the dealer opens three cards (called “Flop”) from among his holding cards. In the game system 1 according to the embodiment, the Flop is displayed on the front display 21, as described below. Here, each player performs a bet selection.

Next, the dealer opens a fourth card (called “Turn”). Then, each player performs a bet selection.

Next, the dealer opens a fifth card (called “River”). Then, each player performs a bet selection.

Next, all the cards (cards dealt first) held by players remaining in the game are open (called Showdown), and each player makes a hand by combining two holding cards and three cards from among five cards of the dealer. All the bet chips are given to a player who has made the strongest hand by comparing the hands of the players.

When the hands in Hold'em Poker are arranged in the order of their strength, there are royal flush, straight flush, four cards, full house, flush, straight, three cards, two pairs, one pair, and no pair.

Next, images displayed on the front display 21 and the liquid crystal display 10 during a game will be described.

The image displayed on the front display 21 will now be described with reference to FIG. 1.

As shown in FIG. 1, in an approximate center of the front display 21, a dealer 30 is displayed.

Below the dealer 30, a table 31 is displayed. On the table 31, five card images 32 representing five cards and a chip image 33 representing bet chips are displayed.

In addition, below the table 31, game information display sections 35 in which face images and game information of the players are displayed are arranged. In each game information display section 35, a face image and game information of a player using a corresponding station 3 are displayed.

The game information includes the number of bets, which have been placed until now, of each player and information on the bet selection. In addition, when a Showdown process is performed, cards dealt first to the players are displayed in the game information display sections 35 by replacing the face images.

When there is a station 3 that is not used for the game, game information on a player who has a turn to perform a bet selection is displayed in the game information display section 35 corresponding to the station 3.

In the left end of the upper portion of the front display 21, an enlarged face image displaying section 36 is arranged. In the enlarged face image displaying section 36, the face image of a player who has a turn to receive a card or make a bet selection is displayed in an enlarged size.

In the right end of the upper potion of the front display 21, a pot display section 34 for displaying the total amount of chips currently bet is arranged.

In the embodiment, although an image displayed on one front display 21 between the front displays 21 of two main displays 2 is configured to be the same as an image displayed on the other front display 21, it may be configured that different images are displayed on the two first display units in accordance with the progress of a game.

FIG. 5 is a diagram showing an example of an image displayed on the liquid crystal display of the station. As shown in FIG. 5, in the left end of the upper portion of the liquid crystal display 10, a player face image displaying section 76 for displaying a face image of a player playing a game in the station 3 is arranged. In the player face image displaying section 76, the face image of the player playing the game in the station 3 which is captured by the camera 16 is continuously displayed.

The player can check his facial expression shown to other players by looking at the image displayed on the player face image displaying section 76.

Below the player face image displaying section 76, two card images 70 representing two cards dealt to the player at the start of the game are shown.

Below the card images 70, a bet display section 71 for displaying the current number of bets of the player is arranged.

In an approximate center portion of the liquid crystal display 10 on the lower side, a designated player face image displaying section 77 for displaying the face image of a player designated by the player playing the game in the station 3 is arranged.

In the right end of the liquid crystal display 10 on the upper side, a player selection section 78 for selecting a player to be displayed in the designated player face image displaying section 77 is arranged. The player can designate the player whose face image is to be displayed by touching a portion on the touch panel 11 corresponding to an alphabet of a station 3 in which the player whose face image is wanted to be displayed plays the game. The touch panel 11 serves as an input device according to the present invention.

Below the player selection section 78, a bet selection section 72 for selecting a “bet”, a call selection section 73 for selecting a “call”, a raise selection section 74 for selecting a “raise”, and a fold selection section 75 for selecting a “fold” are arranged for the bet selection. The player can perform the bet selection by touching a portion on the touch panel 11 corresponding to a selection section.

Next, the internal configuration of the game system 1 will be described.

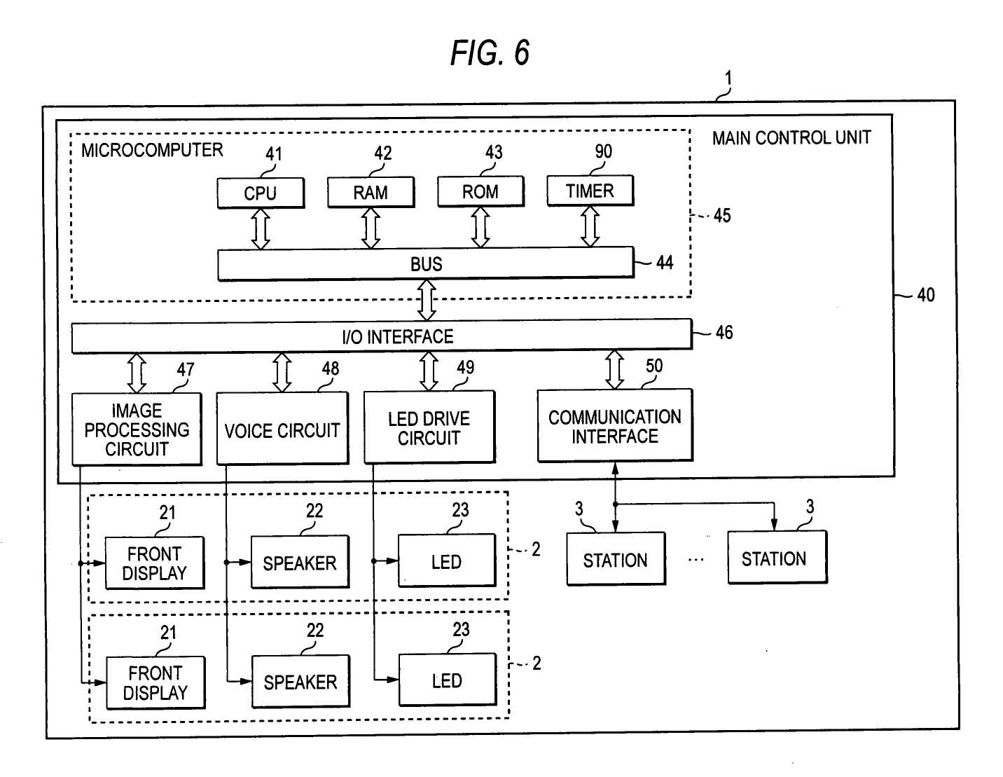

FIG. 6 is a block diagram showing the internal configuration of the game system according to the embodiment.

As shown in FIG. 6, the game system 1 has a main control unit 40, a plurality of stations 3 connected to the main control unit 40, and two main displays 2.

The main control unit 40 includes a microcomputer 45 basically having a CPU 41, a RAM 42, a ROM 43, a timer 90, and a bus 44 for data transmission therebetween, as a core component. The main control unit 40 corresponds to a controller according to the present invention. In the ROM 43, various programs, data tables, and the like for performing processes required for controlling the game system 1 are stored. The RAM 42 is a memory for temporarily storing various types of data calculated by the CPU 41. The timer 90 measures a time.

The CPU 41 is connected to an image processing circuit 47, a voice circuit 48, an LED drive circuit 49, and a communication interface 50 through an I/O interface 46.

The front display 21 is connected to the image processing circuit 47. The speakers 22 are connected to the voice circuit 48. The LEDs 23 are connected to the LED drive circuit 49. Ten stations 3 are connected to the communication interface 50.

The main control unit 40 also performs operations for outputting an image signal to be displayed on the front display 21 and controlling drive of the speakers 22 and LEDs 23.

Next, the internal configuration of the station 3 will be described.

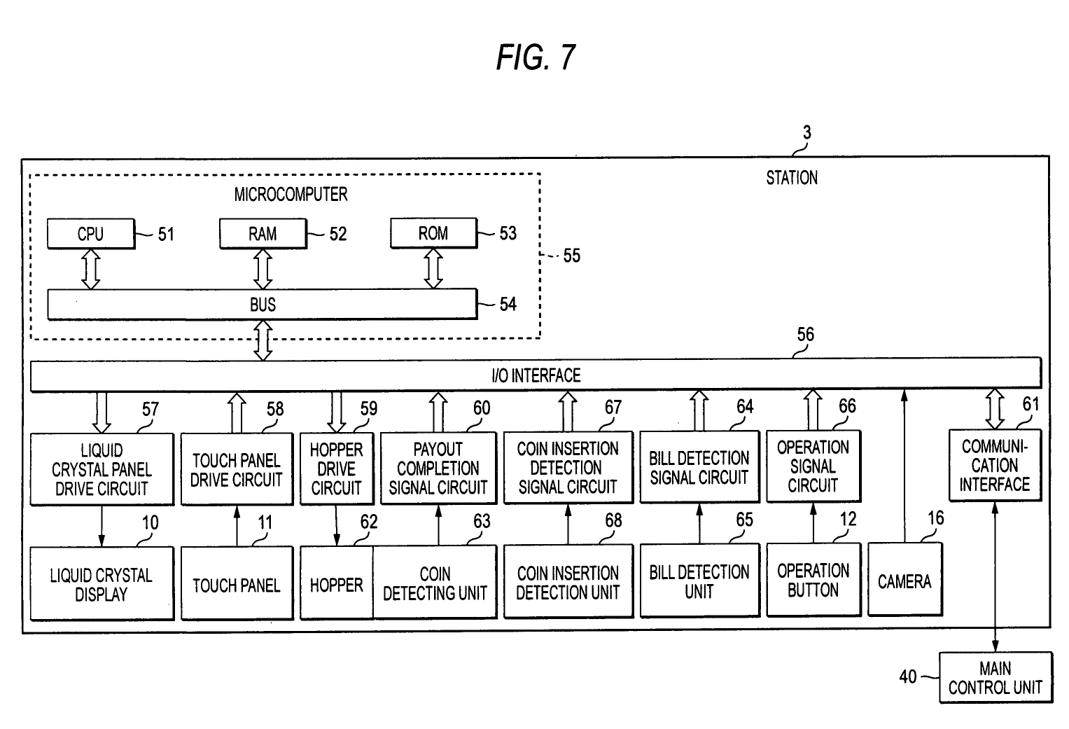

FIG. 7 is a block diagram showing the internal configuration of the station according to the embodiment.

As shown in FIG. 7, the station 3 includes a microcomputer 55 basically having a CPU 51, a RAM 52, a ROM 53, and a bus 54 for data transmission therebetween, as a core component.

In the ROM 53, various programs, data tables, and the like required for performing processes of controlling the station 3 are stored. The RAM 52 is a memory for temporarily storing the number of credits currently stored in the station 3 or various types of data calculated by the CPU 51.

The CPU 51 is connected to a liquid crystal panel drive circuit 57, a touch panel drive circuit 58, a hopper drive circuit 59, a payout completion signal circuit 60, a coin insertion detection signal circuit 67, a bill detection signal circuit 64, an operation signal circuit 66, a camera 16, and a communication interface 61, through an I/O interface 56.

A liquid crystal display 10 is connected to the LCD drive circuit 57. A touch panel 11 is connected to the touch panel drive circuit 58. A hopper 62 is connected to the hopper drive circuit 59. A coin detecting unit 63 is connected to the payout completion signal circuit 60. A coin insertion detecting unit 68 is connected to the coin insertion detection signal circuit 67. A bill detecting unit 65 is connected to the bill detection signal circuit 64. An operation button 12 is connected to the operation signal circuit 66.

The hopper 62 is disposed inside the station 3 and pays out coins from the coin payout opening 15 on the basis of a control signal output from the CPU 51.

The coin detecting unit 63 is disposed inside the coin payout opening 15. When detecting payout of a predetermined number of coins from the coin payout opening 15, the coin detecting unit 63 transmits a signal to the CPU 51.

When detecting insertion of a coin into the coin insertion slot 13, the coin insertion detecting unit 68 detects the amount of the coin and transmits a detection signal indicating the detected amount to the CPU 51.

When receiving a bill, the bill detecting unit 65 detects the amount of the bill and transmits a detection signal indicating the detected amount to the CPU 51.

The operation button 12 is used for performing a payout operation in a case where payout of coins is determined.

The camera 16 is used for capturing an image of a face of a player playing a game. In the embodiment, face image data acquired by an image capturing operation of the camera 16 is transmitted to the CPU 41 and the CPU 51.

Next, a process performed in the game system 1 will be described.

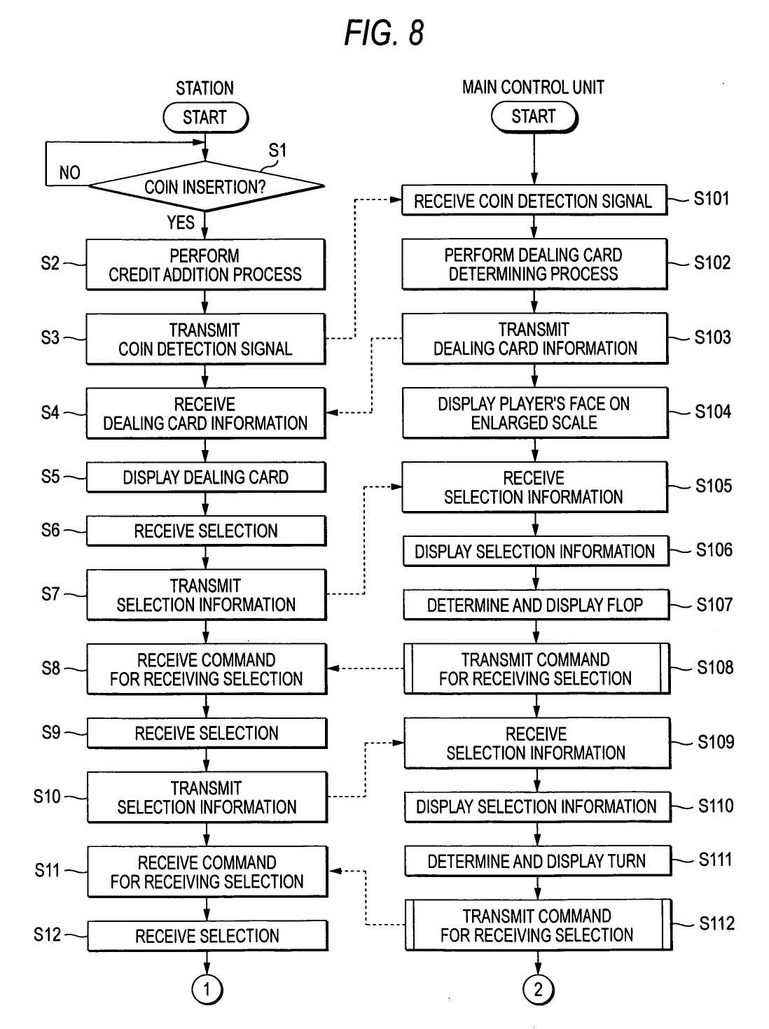

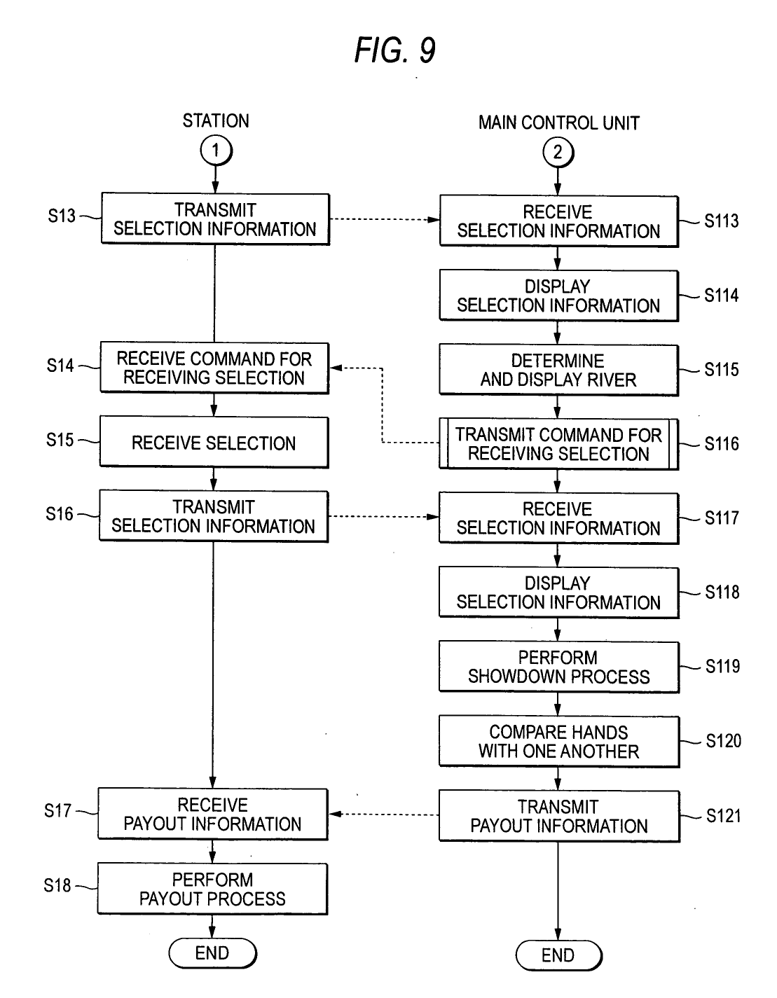

FIGS. 8 and 9 are flowcharts showing a game process according to the embodiment.

First, a process performed in each station 3 will be described.

In Step S1 shown in FIG. 8, the CPU 51 determines whether a coin is inserted by a player. When it is determined that a coin has not been inserted, the process proceeds back to Step S1. On the other hand, when it is determined that a coin has been inserted, the CPU 51 adds credits corresponding to the inserted coin to the credits stored in the RAM 52, in Step S2.

In Step S3, the CPU 51 transmits a coin detection signal to the CPU 41 of the main control unit 40.

In Step S4, the CPU 51 receives dealing card information, which is information on two cards dealt to the player, from the CPU 41 of the main control unit 40. The dealing card information includes numbers, alphabets, and marks.

In Step S5, the CPU 51 displays the two cards on the liquid crystal display 10 on the basis of the dealing card information received in Step S4 (see FIG. 5).

In Step S6, the CPU 51 receives a bet selection. In this step, the player performs the bet selection on the touch panel 11.

In Step S7, the CPU 51 performs a process for transmitting information (hereinafter, also referred to as selection information) on the bet selection input by the player to the CPU 41 and subtracting credits corresponding to the bet chips from the credits stored in the RAM 52. The selection information includes information on the number of chips betted by the player.

When receiving the selection information, the main control unit 40 performs a process for displaying the received selection information in the game information display section 35 of the front display 21, a process for accumulating and storing credits corresponding to the bet chips in the RAM 42, a process for determining three cards to be Flop and displaying the determined cards on the front display 21, and a process for transmitting a direction signal for receiving a bet selection to the CPU 51.

Next, the CPU 51 receives the direction signal for receiving a bet selection from the CPU 41 (Step S8), receives the bet selection (Step S9), and transmits the selection information to the CPU 41 and subtracts the credits corresponding to the bet chips from the credits stored in the RAM 52 (Step S10).

When receiving the selection information, the main control unit 40 performs a process for displaying the received selection information in the game information display section 35 of the front display 21, a process for accumulating and storing credits corresponding to the bet chips in the RAM 42, a process for determining a card to be Turn and displaying the determined card on the front display 21, and a process for transmitting a direction signal for receiving a bet selection to the CPU 51.

Next, the CPU 51 receives the direction signal for receiving a bet selection from the CPU 41 (Step S11), receives a bet selection (Step S12), transmits the selection information to the CPU 41, and subtracts credits corresponding to the bet chips from the credits stored in the RAM 52 (Step S13 shown in FIG. 9).

When receiving the selection information, the main control unit 40 performs a process for displaying the received selection information in the game information display section 35 of the front display 21, a process for accumulating and storing credits corresponding to the bet chips in the RAM 42, a process for determining a card to be River and displaying the determined card on the front display 21, and a process for transmitting a direction signal for receiving a bet selection to the CPU 51.

Next, the CPU 51 receives the direction signal for receiving a bet selection from the CPU 41 (Step S14), receives bet selection (Step S15), transmits the selection information to the CPU 41, and subtracts credits corresponding to the bet chips from the credits stored in the RAM 52 (Step S16).

In Step S17, the CPU 51 receives information (hereinafter, also referred to as payout information) on the number of payouts from the CPU 41.

In particular, the CPU 51 receives information on the credit amount that has been accumulatively stored in the RAM 42 of the main control unit 40 from the CPU 41.

In Step S18, the CPU 51 pays out credits on the basis of the payout information received in Step S17.

In particular, the CPU 51 stores the information on the credit amount accumulatively stored in the RAM 42 which has been received from the CPU 41 in the RAM 52. Then, when the operation button 12 is pressed, the CPU 51 pays out coins corresponding to the number of credits stored in the RAM 52 from the coin payout opening 15.

After the process of Step S18 is performed, the game process is completed.

Next, a process performed by the main control unit 40 will be described.

In Step S101, the CPU 41 receives a coin detection signal from the CPU 51 of the station 3.

In Step S102, the CPU 41 determines two cards to be dealt to each player by using random numbers.

In Step S103, the CPU 41 transmits information on the cards determined in Step S102 to the CPU 51.

In Step S104, the CPU 41 displays the player's face image (that is, the face image of a player who has a turn to receive a card) received from the camera 16 of the station 3 that has transmitted the card information in Step S103 in the enlarged face image displaying section 36 of the front display 21.

After the processes of Steps S103 and S104 are performed for all the stations 3, the process proceeds to Step S105.

In Step S105, the CPU 41 receives the selection information from the CPU 51. Then, in Step S106, the CPU 41 displays the selection information received in Step S105 in the game information display section 35 of the front display 21 and accumulates and stores credits corresponding to the bet chips in the RAM 42 on the basis of the received selection information.

After the processes of Steps S105 and S106 are performed for all the stations 3, the process proceeds to Step S107.

In Step S107, the CPU 41 determines three cards by using random numbers and displays the determined cards as Flop on the table 31 of the front display 21.

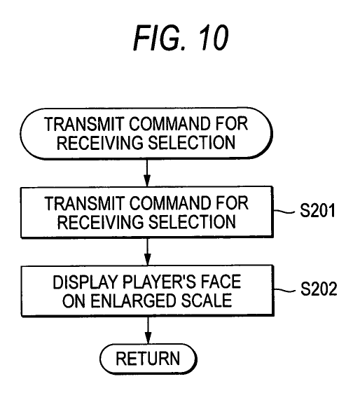

In Step S108, the CPU 41 performs a process for transmitting a command for receiving a selection. This process will be described later in detail with reference to FIG. 10.

In Step S109, the CPU 41 receives the selection information from the CPU 51. Then, in Step S110, the CPU 41 displays the selection information received in Step S109 in the game information display section 35 of the front display 21 and accumulates and stores credits corresponding to the bet chips in the RAM 42 on the basis of the received selection information.

After the processes of Steps S108 to S110 are performed for all the stations 3, the process proceeds to Step S111.

In Step S111, the CPU 41 determines one card by using a random number and displays the determined card as Turn on the table 31 of the front display 21.

In Step S112, the CPU 41 performs a process for transmitting a command for receiving a selection.

In Step S113 shown in FIG. 9, the CPU 41 receives selection information from the CPU 51. Then, in Step S114, the CPU 41 displays the selection information received in Step S113 in the game information display section 35 of the front display 21 and accumulates and stores credits corresponding to the bet chips in the RAM 42 on the basis of the received selection information.

After the processes of Steps S112 to S114 are performed for all the stations 3, the process proceeds to Step S115.

In Step S115, the CPU 41 determines one card by using a random number and displays the determined card as River on the table 31 of the front display 21.

In Step S116, the CPU 41 performs a process for transmitting a command for receiving a selection.

In Step S117, the CPU 41 receives selection information from the CPU 51. Then, in Step S118, the CPU 41 displays the selection information received in Step S117 in the game information display section 35 of the front display 21 and accumulates and stores credits corresponding to the bet chips in the RAM 42 on the basis of the received selection information.

After the processes of Steps S116 to S118 are performed for all the stations 3, the process proceeds to Step S119.

In Step S119, the CPU 41 performs a Showdown process.

In particular, the CPU 41 displays each two cards that have been dealt to a player using each station 3 in the game information display section 35 corresponding to the station 3.

In Step S120, the CPU 41 compares the hands with one another.

In particular, first, the CPU 41 determines a strongest hand among hands made by combining two cards dealt to one player and three cards among five cards displayed on the table 31 of the front display 21 as the hand of the player. After the same process as that described above is performed for all the players remaining in the game, the CPU 41 compares the hands of the players to one another and determines a player whose hand is the strongest.

In Step S121, the CPU 41 transmits the payout information to the CPU 51.

In particular, the CPU 41 transmits the information on the credit amount accumulatively stored in the RAM 42 to the CPU 51.

After the process of Step S121 is performed, the game process is completed.

FIG. 10 is a flowchart showing a subroutine for the process for transmitting a command for receiving a selection which is performed by the main control unit in Steps S108 and S112 shown in FIG. 8 and Step S116 shown in FIG. 9.

In Step S201, the CPU 41 transmits a direction signal for receiving a bet selection to the CPU 51.

When receiving the direction signal for receiving a bet selection, the station 3 performs a process of receiving the bet selection and a process of transmitting the input selection information to the CPU 41.

In Step S202, the CPU 41 displays the player's face image (that is, the face image of a player who has a turn to perform a bet selection) received from the camera 16 of the station 3 that has transmitted the direction signal for receiving a bet selection in Step S201 in the enlarged face image displaying section 36 of the front display 21.

After the process of Step S202 is performed, the subroutine is completed.

Next, a process of displaying the face image of a player designated by the player playing a game in the station 3 in the liquid crystal display 10 of the station 3 will be described.

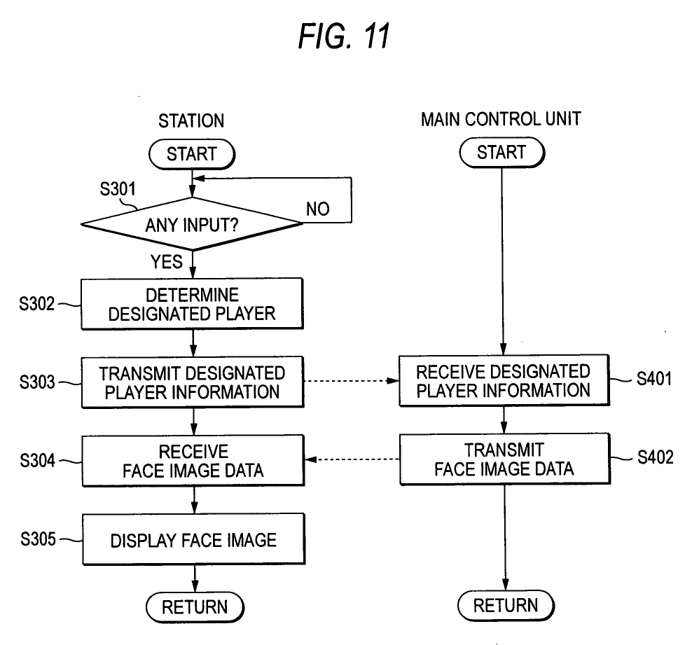

FIG. 11 is a flowchart showing a subroutine for a process of displaying the face image of a designated player which is performed at regular time intervals by the station and the main control unit, independently of the game process shown in FIGS. 8 and 9.

This subroutine is executed only when an input for designating a player whose face is to be displayed is performed by the player.

First, in Step S301, the CPU 51 of the station 3 determines whether an input for designating a player whose face image is to be displayed is performed by the player. In this process, the CPU 51 determines whether an alphabet in the player selection section 78 (see FIG. 5) is selected through the touch panel 11. When it is determined that an input for designating the player whose face image is to be displayed is not performed, the process proceeds back to S301.

On the other hand, when it is determined that an input for designating the player whose face image is to be displayed is performed, the CPU 51 determines the designated player in Step S302. In this process, the CPU 51 determines which alphabet has been selected in Step S301.

In Step S303, the CPU 51 transmits information on the designated player (hereinafter, referred to as designated player information) to the CPU 41 of the main control unit 40.

In Step S401, the CPU 41 of the main control unit 40 receives the designated player information from the CPU 51 of the station 3.

In Step S402, the CPU 41 transmits the face image data received from the station 3 in which the designated player plays a game to the CPU 51.

Next, in Step S304, the CPU 51 of the station 3 receives the face image data of the designated player from the CPU 41.

In Step S305, the CPU 51 displays the designated player's face image on the basis of the face image data received in Step S304 in the designated player face image displaying section 77 of the liquid crystal display 10 of the station 3.

In the embodiment, the face image displayed in the designated player face image displaying section 77 continues to be displayed until the end of the game when a player is not newly designated. On the other hand, when a new player is designated, the displayed face image is replaced with the face image of the new player.

However, a time for displaying the designated player's face image is not limited to the above-described example. For example, the designated player's face image may be displayed for a predetermined time.

After performing the process of Step S305, the subroutine is completed.

As described above, the game system 1 according to the embodiment has the front display 21 (first display unit). The game system 1 has ten stations 3, which are used for the players to play the game, each including the liquid crystal display 10 (second display unit), the camera 16 for capturing an image of the face of the player playing a game, and the touch panel 11 (an input device) for selecting a player whose face image is to be displayed on the liquid crystal display 10. The game system 1 has the main control unit 40 (controller) that is programmed to execute the following processes of “(a)” to “(c)”.

(a) A process of controlling an operation for capturing image of the faces of the players playing the game in the stations 3 having the cameras 16 by using the cameras 16.

(b) A process of controlling an operation for displaying images of the players' faces which have been captured by the cameras 16 on the front display 21.

(c) A process of controlling an operation for displaying the face image of the player, who is selected by each touch panel 11, captured by the camera 16 on the liquid crystal displays 10 of each station 3.

In the embodiment, although the image capturing operations are continuously performed by the cameras 16, however, the method of capturing images by the cameras is not limited thereto. For example, the image capturing operations may be performed only at predetermined timings (for example, at a time when a bet selection is made or a card is dealt) or only when a predetermined condition (for example, a condition that the amount of the pot exceeds a predetermined amount or a raise of an amount equal to or larger than a predetermined amount is made) is satisfied. The face image data acquired by the image capturing operations by using the cameras may be stored in the memory.

Although the face images acquired by the image capturing operations by using the cameras 16 are configured to be continuously displayed on the front display 21 in the embodiment, the present invention is not limited thereto. For example, the face images may be configured to be displayed only at predetermined timings (for example, at a time when a bet selection is made or a card is dealt) or only when a predetermined condition (for example, a condition that the amount of the pot exceeds a predetermined amount or a raise of an amount equal to or larger than a predetermined amount is made) is satisfied.

Although the face images of all the players participating in the game are configured to be displayed on the front display 21 in the embodiment, the present invention is not limited thereto. For example, only the face image of a player who has a turn to receive a card or make a bet selection may be configured to be displayed on the first display unit. Alternatively, only the face image of a player who satisfies a predetermined condition (for example, a player who makes a raise) is satisfied may be configured to be displayed on the first display unit.

Although the face image of a player playing the game in the station 3 and the face image of a player designated by the player are configured to be displayed on the liquid crystal display 10 of the station 3 in the embodiment, the face images displayed on the second display unit is not limited thereto. For example, the face images of all the players participating in the game may be displayed therein, or only the face image of a player who satisfies a predetermined condition (for example, a player who makes a raise) may be configured to be displayed. Furthermore, the face images may be configured to be continuously displayed on the second display unit, or the face images may be configured to be displayed only at predetermined timings (for example, at a time when a bet selection is made or a card is dealt) or only when a predetermined condition (for example, a condition that the amount of the pot exceeds a predetermined amount or a raise of an amount equal to or larger than a predetermined amount is made) is satisfied.

In the embodiment, although the face image of a player selected by the player playing the game is displayed on the liquid crystal display 10 of the station 3 to which the selection operation is input, in the present invention, the face image of the selected player may be displayed on second display units of stations other than the station to which the selection operation is input.

In the present invention, the positions in which the face images are displayed on the first display unit and the second display unit are not limited to those shown in the examples of FIGS. 1 and 5.

Although a case where the game system 1 has two main displays 2 disposed back to back has been described in the embodiment, the game system according to the present invention is not limited thereto.

Hereinafter, examples of game systems having configurations other than the configuration of the game system 1 will be described.

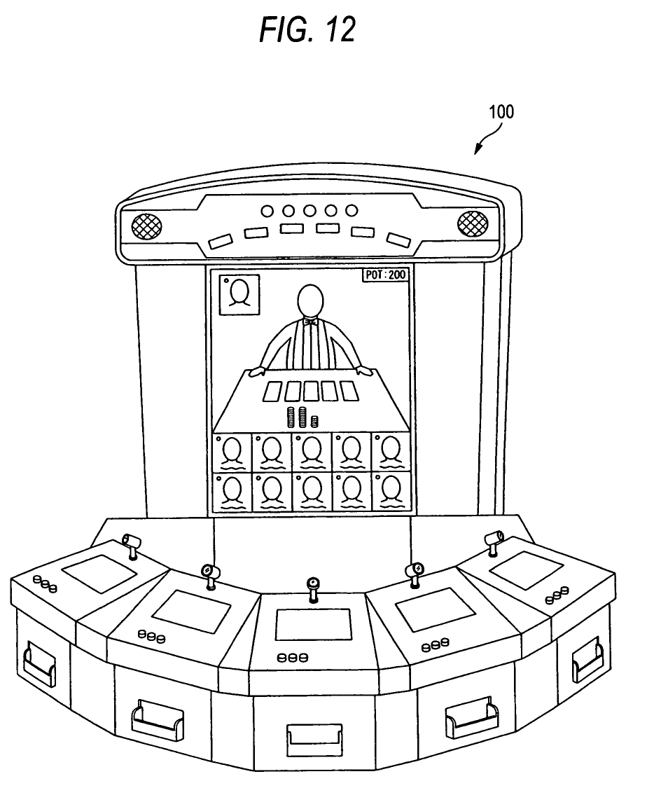

FIG. 12 a perspective view showing the appearance of a game system according to another embodiment.

As shown in FIG. 12, a game system 100 has one main display, and it is configured that all the players participating in the game play the game while viewing the same main display.

As described above, the present invention can be applied to a game system having one main display.

The game system according to an embodiment may not have a second display unit.

Although a case where Hold'em Poker is played as a game has been described in the above-described embodiments, the game performed by the game system is not limited to a specific game as long as the game is played by a plurality of players while a common first display unit is viewed.

As described with reference to the embodiments, there is provided a game system in which the faces of the players playing the game in the stations having the cameras are captured by using the cameras, and images of the players' faces which have been captured by the cameras are displayed on the first display unit. Thus, each player can visually recognize the face images of other players by looking at the first display unit, and accordingly, the player can recognize facial expressions of other players while playing the game. As a result, each player can set up a strategy on the basis of the facial expressions of other players, and it is possible to increase enjoyment of game tactics.

In addition, since the captured images of the players' faces are displayed on the first display unit, game audiences standing in positions from which the first display unit can be visually recognized can acquire the progress state of the game and facial expressions of the players. As a result, it is possible to increase interests of the audiences for the game and enjoyment of viewing the game. In addition, since the audiences can visually recognize the facial expressions of the players, reactions of the audiences are improved, and thereby the whole aspects of the game can be encouraged. Therefore, it is possible to provide a new entertaining feature that has not been in a conventional technology.

There is also provided a game system in which the faces of the players playing the game in the stations having the cameras are captured by using the cameras, and images of the players' faces which have been captured by the cameras are displayed on the first display unit. The images of the players' faces captured by the cameras are displayed on the second display units of the stations. Thus, each player can visually recognize the face images of other players by looking at the first display unit, and accordingly, the player can recognize facial expressions of other players while playing the game. As a result, each player can set up a strategy on the basis of the facial expressions of other players, and it is possible to increase enjoyment of game tactics.

In addition, since the captured images of the players' faces are displayed on the first display unit, game audiences standing in positions from which the first display unit can be visually recognized can acquire the progress state of the game and facial expressions of the players. As a result, it is possible to increase interests of the audiences for the game and enjoyment of viewing the game. In addition, since the audiences can visually recognize the facial expressions of the players, reactions of the audiences are improved, and thereby the whole aspects of the game can be encouraged. In addition, since the images of other players' faces are displayed on the second display unit of each station, the player in the station can look at the facial expressions of other players at close. Accordingly, each player can recognize the facial expressions of other player more precisely.

In addition, since the images of other players' faces are displayed on the second display unit, each player can have a realistic feeling that the player competes with other players whose face images are displayed. As a result, it is possible to increase enjoyment of participating in the game. Therefore, it is possible to provide a new entertaining feature that has not been in a conventional technology.

There is also provided a game system in which the faces of the players playing the game in the stations having the cameras are captured by using the cameras, and images of the players' faces which have been captured by the cameras are displayed on the first display unit. The face image of a player selected by using the input device is displayed on the second display unit of each station. Thus, each player can visually recognize the face images of other players by looking at the first display unit, and accordingly, the player can recognize facial expressions of other players while playing the game. As a result, each player can set up a strategy on the basis of the facial expressions of other players, and it is possible to increase enjoyment of game tactics.

In addition, since the captured images of the players' faces are displayed on the first display unit and the like, game audiences standing in positions from which the first display unit can be visually recognized can acquire the progress state of the game and facial expressions of the players. As a result, it is possible to increase interests of the audiences for the game and enjoyment of viewing the game. In addition, since the audiences can visually recognize the facial expressions of the players, reactions of the audiences are improved, and thereby the whole aspects of the game can be encouraged.

In addition, since the face image of the player selected by using the input device is displayed on the second display unit of each station, the player can view a facial expression of a competitive player at close. Accordingly, it is possible to increase eagerness of the player for the game.

In addition, since each player can acquire the facial expression of his competitive player, the player can set up a strategy more precisely. Therefore, it is possible to provide a new entertaining feature that has not been in a conventional technology.

According to the present invention, there is provided a game system having the above-described new entertaining feature that has not been in the conventional technology, that is, a game system capable of increasing enjoyment of game tactics and enjoyment of viewing the game and encouraging the whole aspects of the game.

While the embodiments of the present invention have been described as above, the embodiments are merely detailed examples of the present invention, and therefore the present invention is not particularly limited thereto, and the design of detailed configurations of each means and the like may be changed appropriately. The advantages described in the embodiments of the present invention are merely examples of appropriate advantages that are generated from the present invention, and therefore the advantages of the present invention are not limited thereto.

In the description of the present invention described above, distinctive features of the present invention have been focused for easy understanding thereof. The present invention is not limited to the embodiments described in the detailed description and may be applied to other embodiments, and the present invention can be applied to various application fields. The terms and expressions used in this specification are not for limiting the interpretation of the present invention but for precisely describing the present invention. It will be understood that those skilled in the art can easily deduce a different configuration, a system, or a method belonging to the concept of the present invention from the concept of the present invention described in this specification. Accordingly, the description of Claims should be considered to include equivalent configurations without departing from the spirit and scope of the present invention. The purpose of the abstract is to enable Patent Trademark Office, general public organizations, or a technical person or the like belonging to the technical field of the present invention who is not familiar with patents, legal terms, or professional terms to acquire the technical contents and essence of the present application in an easy manner by performing a simple research. Accordingly, the abstract is not intended to limit the scope of the present invention which should be determined by Claims. In order to sufficiently understand the object and distinctive advantages of the present invention, it is required to fully refer to disclosed documents and the like.

The above-described detailed description of the present invention includes processes executed by a computer. The purpose of the descriptions and expressions as above is to enable those skilled in the art to efficiently understand the present invention. In this specification, steps used for inducing one result should be understood as processes without self contradiction. In each step, transmission, reception, record, or the like of electric or magnetic signals is performed. In the processes of the steps, although these signals are represented by bits, values, symbols, letters, terms, numbers, or the like, however, it should be considered that those representations are used only for the convenience of descriptions. Although the processes of the steps may have been described as expressions common to human behavior, basically, the processes described in this specification are performed by various apparatuses. In addition, other configurations required to perform the processes in the steps are apparent from the descriptions above.

What is claimed is:

1. A game system that provides a game in which a plurality of players participate, the game system comprising:
a first display unit that displays an image related to the game;
a plurality of stations that are provided for each of the players to play the game and arranged at positions where the image displayed on the first display unit is viewable by each of the players;
a plurality of camera devices that are respectively provided in each of the stations and capture facial images of the respective players; and
a controller that operates to:
control at least one of the camera devices to capture the facial images; and
control the first display unit to display the facial images captured by the camera devices.

2. The game system according to claim 1, wherein the controller operates to control the camera devices to capture the facial images of all the players currently playing the game.

3. The game system according to claim 1, wherein each of the stations is further provided with a second display unit that displays an image related to the game, and
wherein the controller further operates to control the second display unit to display the facial images captured by the camera devices.

4. The game system according to claim 3, wherein the controller operates to:
control the camera device that is provided in a first station selected from among the stations; and
control the second display unit that is provided in a second station selected from among the stations to display the facial image captured by the camera device of the first station.

5. The game system according to claim 3, wherein each of the stations is provided with an input device that allows the respective players to select at least one of the facial images to be displayed on the second display unit, and
wherein the controller controls each of the second display units of the stations to display the facial images that are selected to be displayed through the input device of the respective stations.

6. The game system according to claim 5, wherein the input device is a touch panel provided on a screen of the second display unit.
